(19) United States
(12) Patent Application Publication
(10) Pub. No.: US 2026/0148239 A1
(43) Pub. Date: May 28, 2026

(54) SYSTEM AND METHODS TO GENERATE ARTIFICIAL INTELLIGENCE (AI) DRIVEN INSIGHTS TO RESOLVE PATRON'S INQUIRIES

(71) Applicant: NICE LTD., Ra'anana (IL)

(72) Inventors: Rakesh SHETE, Pune (IN); Peter LIFSHITS, Kedumim (IL); Karthik CHANDRASHEKARAN, Pune (IN); Adi VATURI, EIN VERED (IL)

(21) Appl. No.: 18/958,849

(22) Filed: Nov. 25, 2024

(51) Int. Cl. G06Q 30/015; G06F 16/334; G06F 16/335; G06F 40/30

(52) U.S. Cl. CPC G06Q 30/015; G06F 16/3347; G06F 16/335; G06F 40/30

(57) ABSTRACT

A customer issue resolution system and methods for resolving a customer issue include receiving an audio interaction between a customer and an agent; converting the audio interaction into text; identifying a customer issue in the text of the interaction; performing a semantic search in a vector database for the customer issue in past customer interactions of a plurality of customers; obtaining a plurality of transcripts of past customer interactions from the vector database that match the customer issue, where the customer issue was resolved, and that have a threshold customer satisfaction score; constructing a large language model (LLM) prompt based on the obtained plurality of transcripts and the customer issue; executing the LLM prompt to return a recommendation to resolve the customer issue; and displaying the recommendation to the agent in real-time.

### TECHNICAL FIELD

The present disclosure relates generally to efficiently resolving customer issues, and more specifically to systems and methods that leverage transcriptions of past interactions between agents and customers to derive insights that are used to resolve customer issues.

### BACKGROUND

Contact centers usually train agents about their products and services. They also usually maintain a Knowledge Base (KB) for the most frequent and relevant questions. Both help agents with the required knowledge while addressing customer queries. The challenge arises when information in the KB and training does not help with customer queries and requires additional inputs and details to resolve.

The conventional approach is to build and maintain a KB for the frequently asked queries. This, however, is not sufficient as it takes time to keep this up to date with newer queries and their resolutions, often leaving the agent at a disadvantage from providing a quick resolution with correct details.

Accordingly, a need exists for systems and methods to resolve customer issues with resolutions not found in the KB.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a customer issue resolution system according to various aspects of the present disclosure.

FIG. 2 illustrates an algorithm according to various aspects of the present disclosure.

FIG. 3 illustrates an LLM prompt and the output of the LLM prompt when identifying a customer issue, according to various aspects of the present disclosure.

FIG. 4 illustrates an LLM prompt and the output of the LLM prompt when generating insights and recommendations for a customer issue, according to various aspects of the present disclosure.

FIG. 5 is a flowchart of a method according to various embodiments of the present disclosure.

FIG. 6 illustrates that identifying the customer issue is based on the system prompt and the transcript of an ongoing interaction, according to various aspects of the present disclosure.

FIG. 7 illustrates that the insights and tips generated by the LLM are based on the system prompt and past interactions, according to various aspects of the present disclosure.

FIG. 8 shows a user interface provided to an agent who handles audio interactions, according to various aspects of the present disclosure.

FIG. 9 is a block diagram of a computer system suitable for implementing one or more components in FIG. 1, according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein leverage large language model (LLM) capabilities to derive insights based on past interactions to provide precise information that can help an agent to resolve a customer query or issue. Contact centers often maintain recordings of the interactions between agents and customers that are used for compliance and auditing purposes. These past interactions can be transcribed and used for analytical purposes. The present systems and methods leverage the transcriptions (after scrubbing and cleansing of private data) and derive insights from them using LLMs that present useful information for the agent to leverage and resolve the customer query.

The transcriptions (also referred to herein as transcripts) of past interactions often include valuable information about real world issues reported by customers. The KB is often created using known procedures and containing known issues with resolutions. So, when real world issues are not in the pre-identified list of known issues in the KB, based on the disclosure herein the transcriptions are a reliable source of information to identify viable solutions offered previously that are not yet captured in the KB. The LLMs bring an ability to work with natural language processing to better help a user understand customer queries in the past transcriptions to quickly present possible solutions and recommendations to solve the issue and help the contact center agent.

In various embodiments, when a customer contacts an agent with a customer issue, the audio interaction is sent to a transcription service that provides a transcript. The transcript of the ongoing audio interaction is analyzed and the customer issue is identified. A semantic search for the customer issue is performed in past transcripts of customer interactions. Past transcripts are searched by the customer issue and metadata in a vector database. These past transcripts are generally for a grouping of past customers, but in one embodiment they are transcripts solely for the specific customer that can help eliminate potential solutions for that customer. In another embodiment, the past transcripts are selected for a successful resolution and the same type of customer based on a selected product or product model having a resolved status that bears potential relevance to the customer issue to help more efficiently focus on potential solutions for the current customer issue. In several embodiments, the customer issue is encoded, and the customer issue is searched in the vector database for transcripts of interactions mentioning semantically close issues based on vector proximity and having a high sentiment and a high-resolution score. The transcripts of relevant exemplary interactions are provided as retrieval-augmented generation (RAG) inputs to an LLM, which outputs recommendations for the agent. In an exemplary embodiment, only the past top ranked interactions with high ratings are used to formulate the recommendation, In some embodiments, well-formed responses to the customer issue are generated by the LLM to assist in resolving the customer issue.

The present invention provides real-time, context-based interaction guidance utilizing previous interactions to provide guidance, which may include potential solutions to a customer issue, as to how an agent can respond to a customer. Utilizing previous interactions as the basis for deriving LLM based insights can help fill the guidance gap where formalized knowledge sources fall short. Additionally, it also helps reduce the need to maintain a current article KB and allows new agents to more rapidly learn information that does not exist yet in the KB.

Advantageously, the present systems and methods provide better customer satisfaction (CSAT) scores as customer queries are resolved more quickly with a better or even “correct” resolution compared to those previously provided without such systems and methods as described herein. Lower average handling times (AHT) are also provided because the insights provide a direct resolution based on previous interactions involving the same topic or question. With reduced AHT, in the long term, the staffing for contact centers can be reduced and/or more interactions can be handled. Moreover, the present invention provides insights in customer issue resolution that can be automatically added to the KB if they are missing. Happy and satisfied agents and customers are the result of the present methods, as the agents have faster access to more reliable information when resolving customer queries. The present invention provides agents with the correct inputs when the existing knowledge sources are insufficient.

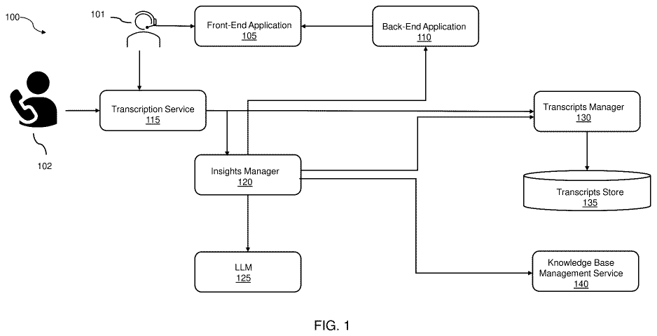

FIG. 1 illustrates a customer issue resolution system 100 according to various aspects of the present disclosure. The system 100 includes Front-End Application 105, Back-End Application 110, Transcription Service 115, Insights Manager 120, LLM 125, Transcripts Manager 130, Transcripts Store 135, and Knowledge Base (KB) Management Service 140.

The Front-End Application 105 is responsible for helping the agent 101 with AI-based suggestions and providing tips and suggestions for the current ongoing interaction with the customer.

The Back-End Application 110 interacts with multiple services to help serve the agent 101 better in the ongoing interaction with AI-based tips and suggestions. The Insights Manager 120 pushes the LLM-based summary and suggestions to this service 110 that then pushes it to the Front-End Application 105 for the agent 101.

The Transcription Service 115 is an existing service that handles the Speech-to-Text (STT) conversion using a third party STT service. The service receives audio of the ongoing interaction from the media servers (not shown here) and performs STT conversion. The transcribed text is published to any service/module interested in using the transcript. In various embodiments, the interaction is transcribed continuously.

The Insights Manager 120 is the main service that derives insights contextualized to the customer query or issue. The Insights Manager 120 uses LLM 125 and the Transcripts Manager 130 for this purpose. The Insights Manager 120 receives the transcribed text in the form of utterances as events from the Transcription Service 115 and leverages LLM 125 to identify the customer issue in the on-going interaction. Alternatively, the agent 101 can also input the customer issue directly in the Front-End Application 105. The Insights Manager 120 then queries the Transcripts Manager 130 to search in the Transcripts Store 135 for transcripts of past interactions mentioning semantically close issues based on vector proximity and having high sentiment and resolution scores. These transcripts are used to generate resolutions and tips using the LLM 125 and are shared with the agent 101 to resolve the customer issue. This is done when the existing KBs do not have a known resolution for the customer issue. Additionally, the newly identified resolution for the customer issue is also updated in the KB using the KB Management Service 140 after human review and is subject to a feedback loop before it is available as a well-known resolution.

The LLM 125 used in the solution could be any LLM offered by a Cloud provider. It may or may not be part of the same Cloud provider as the overall solution.

The Transcripts Manager 130 handles storing the transcription and the metadata associated with the transcription. The Transcripts Manager 130 receives transcribed text in the form of utterances as events from the Transcription Service 115. Once an interaction has ended, the Transcripts Manager 130 runs retrospective analysis (as a background process) determining if the issue was successfully resolved, whether there was customer satisfaction, and recording the final summary. This is done by either a dedicated model or a call to the LLM 125. The final transcript and metadata are saved in the form of a vector index for semantic search later. This service is responsible for allowing queries or searches across multiple past transcriptions based on text and/or metadata.

The Transcript Store 135 stores the transcripts, related metadata and issues discussed on interactions. The Transcript Store 135 enables retrieval of transcripts with metadata semantically close (i.e., most relevant) to the issue queried.

The KB Management Service 140 manages the KB for well-known, frequently referred questions and issues. If the identified resolutions are not in the KB, those are generally added to the KB with human-in-the-loop vetting. Any successful resolutions according to the present disclosure may also be added to the KB for future reference.

In an exemplary embodiment, an ongoing audio interaction between the agent 101 and the customer 102 is provided to the Transcription Service 115. The resulting transcript and its metadata (e.g., sentiment score and resolution score) are provided to the Transcripts Manager 130 and saved in the Transcripts Store 135. The transcript is also provided to the Insights Manager 120, which extracts the customer issue. The customer issue is passed to Transcripts Manager 130, where past audio interactions are searched based on the customer issue and the metadata. Relevant transcripts of past audio interactions are passed by the Insights Manager 120 to the LLM 125. The LLM 125 generates insights and tips based on the past relevant transcripts. These insights and tips are shared by the Insights Manager 120 with the Back-End Application 110, which passes these insights and tips to the Front-End Application 105. The Front-End Application 105 displays the insights and tips to the agent 101 in real-time, who uses the Front-End Application 105 for the ongoing audio interaction.

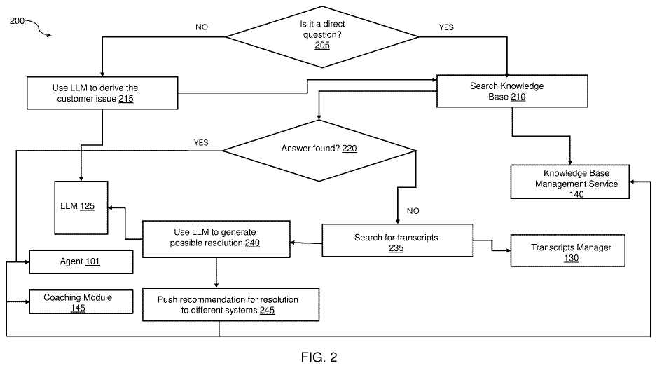

FIG. 2 illustrates an algorithm according to the embodiments of the present disclosure. First, to establish or identify the customer issue at step 205, the algorithm determines if the issue is provided as a direct question. If the Insights Manager 120 receives the customer issue as explicit input from the agent 101 using the Front-End Application 105, the answer is yes. If the answer is no, the Insights Manager 120 needs to form a question to be used to search the KB Management Service 140 by using the LLM 125 in step 215. The Insights Manager 120 uses the LLM 125 to search and derive the customer issue, by providing the entire transcript of the ongoing interaction including the latest message.

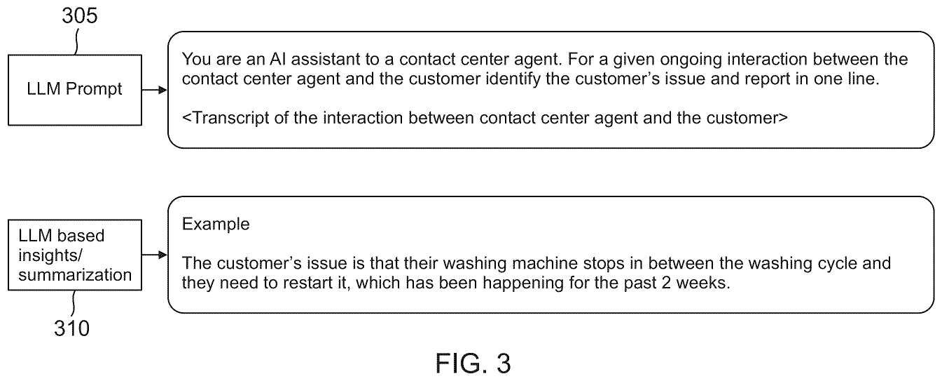

In certain embodiments, an LLM prompt is created to identify the customer issue for the ongoing interaction. Referring to FIG. 3, the LLM prompt 305 includes the system context, which sets the context for the LLM 125 under which the given question is answered. The system context includes some instructions that influence the output of the LLM 125. The LLM prompt 305 also includes the transcript of the ongoing audio interaction that is used by the LLM 125 to identify the customer issue, which can be used by Insights Manager 120 to search in the KB using the KB Management Service 140.

Once each customer issue is identified, in one embodiment, the KB is searched in step 210 for the answer to the question. In several embodiments, the Insights Manager 120 calls the KB Management Service 140 application programming interface (API) with the question to retrieve relevant content. KB Management Service 140 searches the KB content store and looks for helpful information and tips for the given customer issue. If this step 210 returns results and an answer is found in step 220, then it is shared with agent 101 as a known resolution.

If the answer is not found in step 220, the Insights Manager 120 calls the Transcripts Manager 130 to search for transcripts in step 235 that have a matching customer issue with metadata of: resolved=true and high customer satisfaction. For example, in one embodiment, a high customer satisfaction score is a score greater than 75%, such as 85%. In other embodiments, a high customer satisfaction score may be a score greater than 90%, such as 95%. The term “high” in this context may also be relative to a lower CSAT score. The KB is a more formalized source of information reviewed and approved, whereas the transcripts are copies of interactions between agents and customers, which are scrubbed and anonymized. The transcripts can have the latest issues and resolutions recommended by agents that are not yet formalized in the KBs. The matching transcripts are used to generate insights, tips, and possible resolutions using the LLM 125 in step 240.

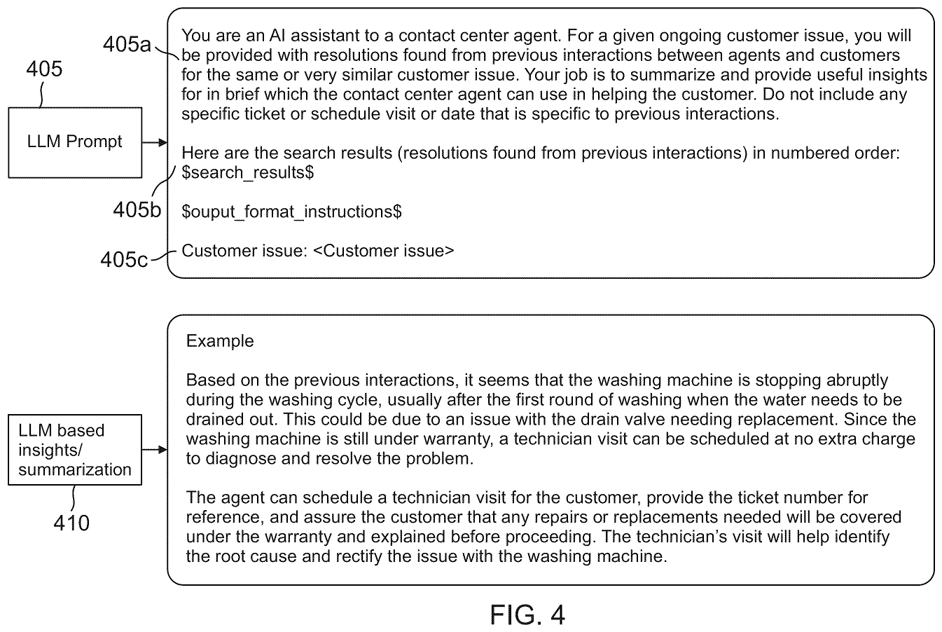

Referring now to FIG. 4, shown is an LLM prompt 405 and the generated insights and inputs 410 based on past matched transcripts. The LLM prompt 405 has three different sections. The first section is the system context 405a, which sets the context for the LLM 125 under which the given question is answered. The system context 405a includes some instructions to influence the output of the LLM 125. The main part of the system context 405a is to use the information and tips from the matching transcripts that is indicated by the “$search_results$” placeholder. The two other sections of the LLM prompt 405 are the placeholder for matching transcripts 405b and the customer's issue 405c. The “$search_results$” placeholder is where the matched transcripts are provided as input to the LLM 125 for summarizing and generating insights. The “$output_format_instructions$” placeholder is used to provide instructions about how the LLM output from the LLM 125 is to be formatted. The customer's issue 405c is the customer issue from which summary and insights need to be generated based on the “$search_results$.” The LLM based insights and summarization 410 is output from the LLM 125.

Going back now to FIG. 2, once a recommendation or resolution has been established by the LLM 125, the recommendation is pushed to different systems in step 245. In some embodiments, the recommendation is used to support automated actions.

For example, the Insights Manager 120 pushes the recommendation to the KB Management Service 140 to bridge the gap for the specific issue. It leverages the KB Management Service 140 API to push the newly generated recommendations with the ID of the matched interactions for the given customer issue. The KB Management Service 140 creates a new article using the matched transcripts and the recommendation, which is then made available for use by agents as a standard resolution.

In another example, the Insights Manager 120 uses the coaching API to create a new coaching package with link(s) to interaction(s) with the highest customer satisfaction that are returned when searching for a transcript. The coaching package includes the issue, reference interaction ID, and the answer provided by the LLM 125. This newly generated coaching package is automatically sent to all agents with the same skill as the skill used in the existing interaction and saved in coaching module 145.

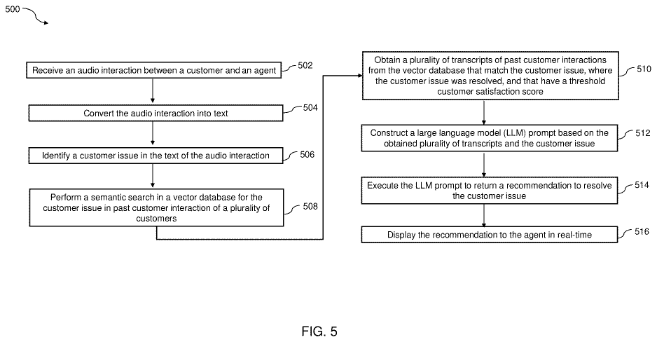

Referring now to FIG. 5, a method 500 according to embodiments of the present disclosure is described. At step 502, the Front-End Application 105 receives an audio interaction between a customer 102 and an agent 101. An audio interaction includes a phone call, a video interaction, or any interaction with an audio component.

At step 504, the Transcription Service 115 converts the audio interaction into text. In some embodiments, a third party STT service is used, such as Google cloud's STT service.

At step 506, the Insights Manager 120 identifies a customer issue in the text of the audio interaction. In certain embodiments, identifying the customer issue includes using the LLM 125 to identify the customer issue. Alternatively, identifying the customer issue includes receiving input directly from the agent 101 to identify the customer issue. In embodiments where the LLM 125 is used, the LLM 125 is called to identify the customer issue.

At step 508, the Transcripts Manager 130 performs a semantic search in a vector database for the customer issue in past customer interactions of a plurality of customers. In one or more embodiments, the identified customer issue is encoded and transcripts of interactions mentioning semantically close issues are searched in the vector database based on vector proximity and high sentiment and resolution scores. In certain embodiments, after an audio interaction is completed, the transcript of the interaction and its metadata is saved as a vector in a vector database. In various embodiments, the Insights Manager 120 searches a KB for an answer to the customer issue before the Transcripts Manager 130 performs the semantic search and fails to find the answer to the customer issue in the KB.

Semantic search is a search engine optimization technique that uses natural language processing and machine learning to understand the context of a search query. Unlike traditional keyword-based searches that rely on exact matches, semantic search takes into account the relationship between words, their contextual significance, and even the intent behind the query.

Semantic search uses embeddings and vector databases. Embeddings are numerical vectors that represent words or phrases in a vector space. Embeddings capture semantic relationships between words by placing similar words closer together in the vector space. For example, in a vector space, words like “tree” and “flower” would be positioned closer to each other compared to “cat” and “sky” due to their semantic relationship.

Vector databases store vector representations and allow semantic searches to be performed. These databases can rapidly identify similar vectors, which makes them ideal for semantic search tasks. Instead of comparing queries against an entire dataset, vector databases narrow down the search by calculating the similarity between the query vector and the stored vectors.

At step 510, the Insights Manager 120 obtains a plurality of transcripts of past customer interactions from the vector database that match the customer issue, where the customer issue was resolved, and that have a threshold customer satisfaction score. The threshold customer satisfaction score can be set by the customer.

At step 512, the Insights Manager 120 constructs an LLM prompt based on the obtained plurality of transcripts and the customer issue. In several embodiments, the LLM prompt further includes a system context.

At step 514, the Insights Manager 120 executes the LLM prompt to return a recommendation to resolve the customer issue.

At step 516, the Insights Manager 120 displays the recommendation to the agent 101 in real-time. In one or more embodiments, KB Management Service 140 creates an article based on the recommendation, and saves the article in the KB. In some embodiments, KB Management Service 140 updates the customer issue with the recommendation in the KB.

In one or more embodiments, Coaching Module 145 generates a coaching package including the customer issue, the recommendation, and related customer interactions, and assigns the coaching package to an agent in need of coaching for the customer issue. If multiple customer issues were identified, then each may have the associated recommendation and related customer interactions.

A specific example of the method 500 will now be described in detail. First, a customer issue was identified from an ongoing audio interaction between an agent 101 and a customer 102. The customer issue and resolution were not found in the KB. Next, the customer issue was searched semantically in a vector database. In this case, the five (5) most relevant transcripts were used as context information in the system prompt provided to the LLM 125 along with the customer issue.

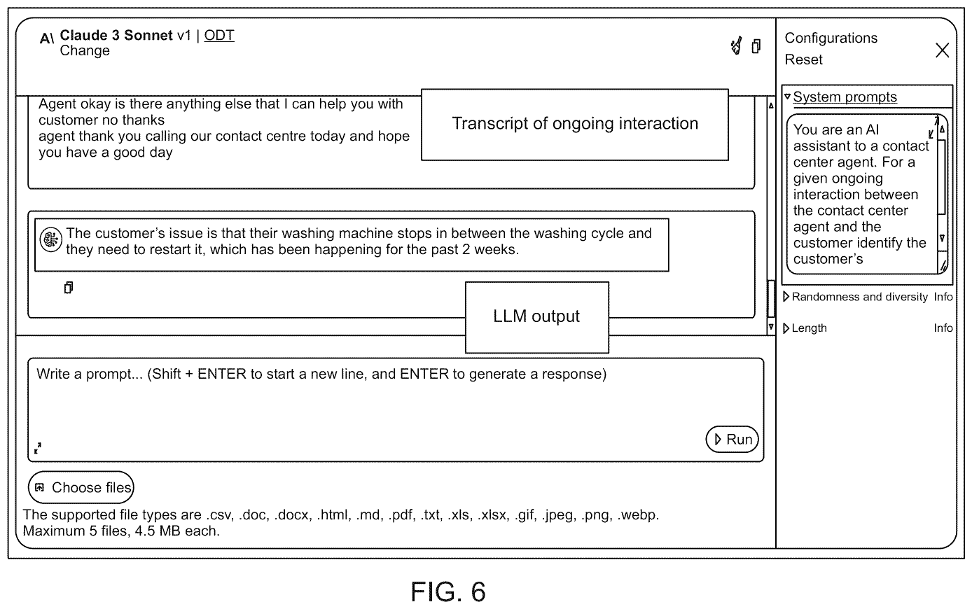

FIG. 6 illustrates that the customer issue is identified from the ongoing interaction using the LLM 125. As shown, the transcript of the ongoing interaction and a system prompt are used to identify the customer issue. The output of the LLM 125 is displayed to the agent 101.

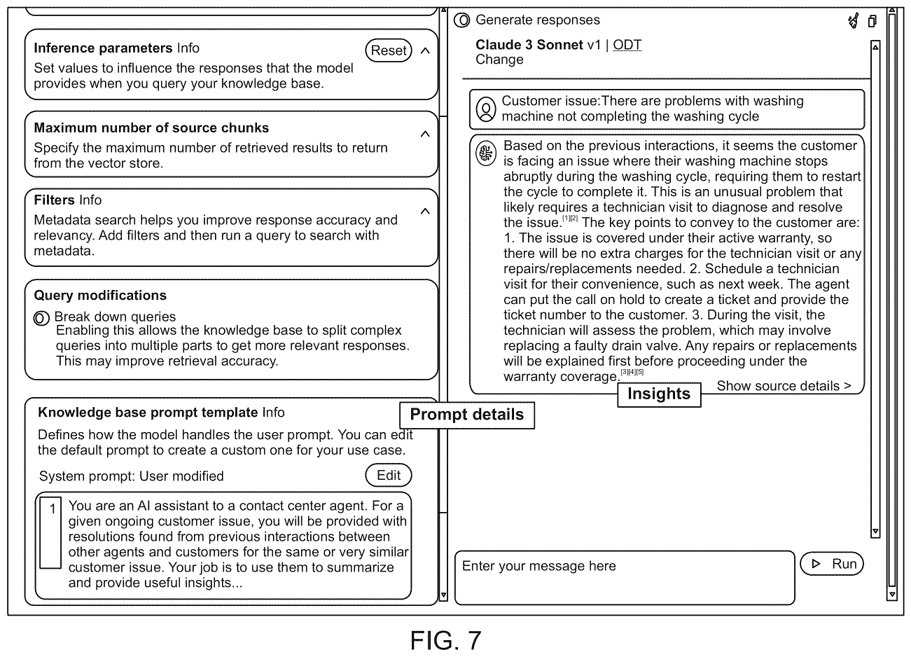

FIG. 7 illustrates that the insights and tips are generated using the LLM 125 based on past matched transcripts and the system prompt. As shown, the prompt details are also used to generate the insights and recommendations.

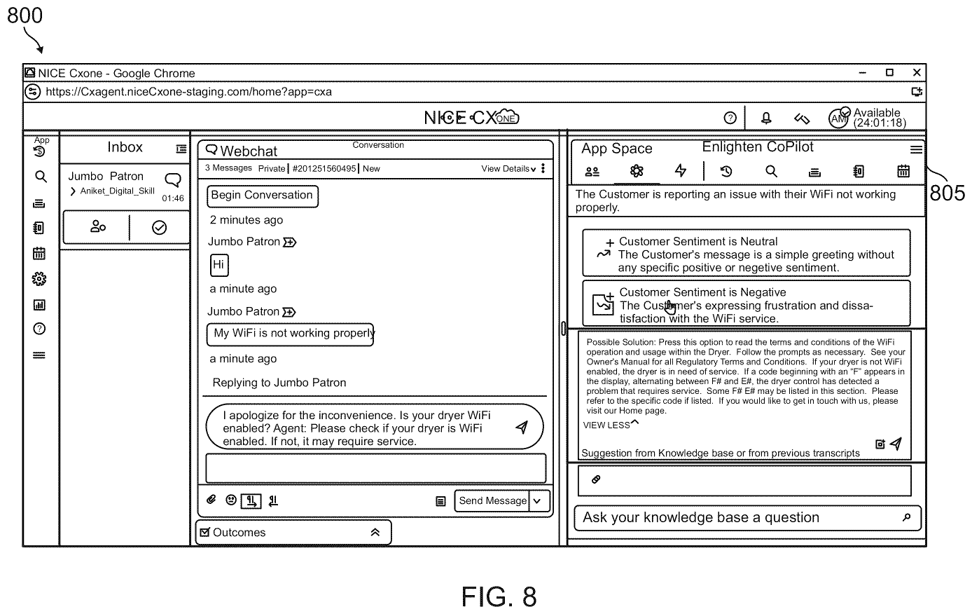

FIG. 8 is a user interface 800 provided to the agent 101 who handles interactions with customers 101. The right panel 805 is where the agent 101 receives assistance. Part of the assistance is searching for the customer issue in the KB to provide accurate guidance on the customer issue. If no answer is found in the KB, the algorithm extends the returned answer by providing guidance from previous customer and agent interactions on topics where the KB is lacking.

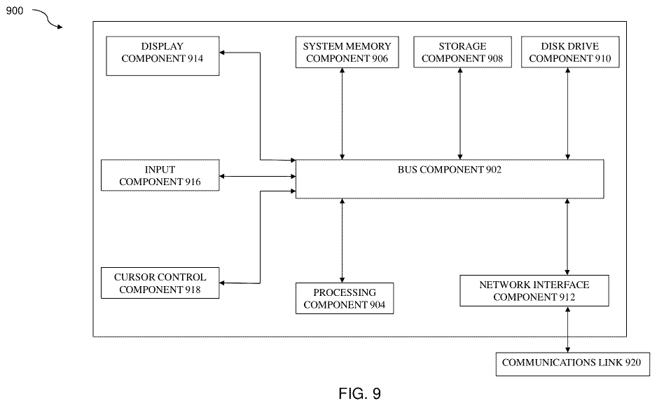

Referring now to FIG. 9, illustrated is a block diagram of a system 900 suitable for implementing embodiments of the present disclosure. System 900, such as part a computer and/or a network server, includes a bus 902 or other communication mechanism for communicating information, which interconnects subsystems and components, including one or more of a processing component 904 (e.g., processor, micro-controller, digital signal processor (DSP), etc.), a system memory component 906 (e.g., RAM), a static storage component 908 (e.g., ROM), a network interface component 912, a display component 914 (or alternatively, an interface to an external display), an input component 916 (e.g., keypad or keyboard), and a cursor control component 918 (e.g., a mouse pad).

In accordance with embodiments of the present disclosure, system 900 performs specific operations by processor 904 executing one or more sequences of one or more instructions contained in system memory component 906. Such instructions may be read into system memory component 906 from another computer readable medium, such as static storage component 908. These may include instructions to receive an audio interaction between a customer and an agent; convert the audio interaction into text; identify a customer issue in the text of the interaction; perform a semantic search in a vector database for the customer issue in past customer interactions of a plurality of customers; obtain a plurality of transcripts of past customer interactions from the vector database that match the customer issue, where the customer issue was resolved, and that have a threshold customer satisfaction score; construct a large language model (LLM) prompt based on the obtained plurality of transcripts and the customer issue; execute the LLM prompt to return a recommendation to resolve the customer issue; and display the recommendation to the agent in real-time. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 904 for execution. Such a medium may take many forms, including but not limited to, non-volatile media, volatile media, and transmission media. In various implementations, volatile media includes dynamic memory, such as system memory component 906, and transmission media includes coaxial cables, copper wire, and fiber optics, including wires that comprise bus 902. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 900. In various other embodiments, a plurality of systems 900 coupled by communication link 920 (e.g., wired or wireless networks) may perform instruction sequences to practice the disclosure in coordination with one another. Computer system 900 may transmit and receive messages, data, information and instructions, including one or more programs (i.e., application code) through communication link 920 and communication interface 912. Received program code may be executed by processor 904 as received and/or stored in disk drive component 910 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A customer issue resolution system comprising:
a processor and a non-transitory computer readable medium operably coupled thereto, the non-transitory computer readable medium comprising a plurality of instructions stored in association therewith that are accessible to, and executable by, the processor, to perform operations which comprise:
receiving an audio interaction between a customer and an agent;
converting the audio interaction into text;
identifying a customer issue in the text of the interaction;
performing a semantic search in a vector database for the customer issue in past customer interactions of a plurality of customers;
obtaining a plurality of transcripts of past customer interactions from the vector database that match the customer issue, where the customer issue was resolved, and that have a threshold customer satisfaction score;
constructing a large language model (LLM) prompt based on the obtained plurality of transcripts and the customer issue;
executing the LLM prompt to return a recommendation to resolve the customer issue; and
displaying the recommendation to the agent in real-time.

2. The customer issue resolution system of claim 1, which further comprises:
searching a knowledge base for an answer to the customer issue before performing the semantic search; and
failing to find the answer to the customer issue in the knowledge base before performing the semantic search.

3. The customer issue resolution system of claim 1, wherein identifying the customer issue in the text of the interaction comprises:
using the LLM to identify the customer issue; or
receiving input from the agent to identify the customer issue.

4. The customer issue resolution system of claim 1, which further comprises:
creating an article based on the recommendation; and
saving the article in the knowledge base.

5. The customer issue resolution system of claim 4, which further comprises updating the customer issue with the recommendation in a knowledge base.

6. The customer issue resolution system of claim 1, which further comprises:
generating a coaching package comprising the customer issue, the recommendation, and related customer interactions; and
assigning the coaching package to an agent in need of coaching for the customer issue.

7. The customer issue resolution system of claim 1, wherein the LLM prompt further comprises a system context.

8. A method for resolving a customer issue, which comprises:
receiving an audio interaction between a customer and an agent;
converting the audio interaction into text;
identifying a customer issue in the text of the interaction;
performing a semantic search in a vector database for the customer issue in past customer interactions of a plurality of customers;
obtaining a plurality of transcripts of past customer interactions from the vector database that match the customer issue, where the customer issue was resolved, and that have a threshold customer satisfaction score;
constructing a large language model (LLM) prompt based on the obtained plurality of transcripts and the customer issue;
executing the LLM prompt to return a recommendation to resolve the customer issue; and
displaying the recommendation to the agent in real-time.

9. The method of claim 8, which further comprises:
searching a knowledge base for an answer to the customer issue before performing the semantic search; and
failing to find the answer to the customer issue in the knowledge base.

10. The method of claim 8, wherein identifying the customer issue in the text of the interaction comprises:
using the LLM to identify the customer issue; or
receiving input from the agent to identify the customer issue.

11. The method of claim 8, which further comprises:
creating an article based on the recommendation; and
saving the article in the knowledge base.

12. The method of claim 1, which further comprises updating the customer issue with the recommendation in a knowledge base.

13. The method of claim 8, which further comprises:
generating a coaching package comprising the customer issue, the recommendation, and related customer interactions; and
assigning the coaching package to an agent in need of coaching for the customer issue.

14. The method of claim 8, wherein the LLM prompt further comprises a system context.

15. A non-transitory computer-readable medium having stored thereon computer-readable instructions executable by a processor to perform operations which comprise:
receiving an audio interaction between a customer and an agent;
converting the audio interaction into text;
identifying a customer issue in the text of the interaction;
performing a semantic search in a vector database for the customer issue in past customer interactions of a plurality of customers;
obtaining a plurality of transcripts of past customer interactions from the vector database that match the customer issue, where the customer issue was resolved, and that have a threshold customer satisfaction score;
constructing a large language model (LLM) prompt based on the obtained plurality of transcripts and the customer issue;
executing the LLM prompt to return a recommendation to resolve the customer issue; and
displaying the recommendation to the agent in real-time.

16. The non-transitory computer-readable medium of claim 15, wherein the operations further comprise:
searching a knowledge base for an answer to the customer issue before performing the semantic search; and
failing to find the answer to the customer issue in the knowledge base.

17. The non-transitory computer-readable medium of claim 15, wherein identifying the customer issue in the text of the interaction comprises:
using the LLM to identify the customer issue; or
receiving input from the agent to identify the customer issue.

18. The non-transitory computer-readable medium of claim 15, wherein the operations further comprise:
creating an article based on the recommendation; and
saving the article in the knowledge base.

19. The non-transitory computer-readable medium of claim 15, wherein the operations further comprise
updating the customer issue with the recommendation in a knowledge base.

20. The non-transitory computer-readable medium of claim 15, wherein the operations further comprise:
generating a coaching package comprising the customer issue, the recommendation, and related customer interactions; and
assigning the coaching package to an agent in need of coaching for the customer issue.
